(19) United States
(12) Patent Application Publication
(10) Pub. No.: US 2007/0104390 A1
(43) Pub. Date: May 10, 2007

(54) Methods for browsing multiple images

(75) Inventor: Jonathan T. Foote, Menlo Park, CA (US)

Correspondence Address: FLIESLER MEYER LLP, 650 CALIFORNIA STREET, 14TH FLOOR, SAN FRANCISCO, CA, 94108, US

(73) Assignee: Fuji Xerox Co., Ltd., Minato-ku (JP)

(21) Appl. No.: 11/405,132

(22) Filed: Apr. 17, 2006

Related U.S. Application Data
(60) Provisional application No. 60/735,054, filed on Nov. 8, 2005.

(51) Int. Cl. G06K 9/36; G09G 5/00

(52) U.S. Cl. 382/284; 345/634

(57) ABSTRACT

Algorithms to show multiple images at the maximum possible resolution are proposed. Rather than reducing the resolution of each image, the portion of each image that is actually shown is reduced. The algorithms select which part of each image is to be shown. In one embodiment of the invention, changing the parameters over time further increases the information displayed.

### PRIORITY CLAIMS

This application claims priority under 35 U.S.C. 119(e) to U.S. Provisional Application No. 60/735,054 filed Nov. 8, 2005, by Jonathan Foote, entitled METHODS FOR BROWSING MULTIPLE IMAGES (Attorney Docket No. FXPL-01111US0 MCF/AGC) which is incorporated herein by reference.

### FIELD OF THE INVENTION

The present invention relates to a method for browsing multiple images on image display devices.

### BACKGROUND OF INVENTION

Given an image capture device, it is highly desirable to view the captured images stored on the device. In some cases, the primary function of the capture device is to view images stored therein.

As these devices become increasingly popular, and as their storage capacities increase the number of images to be viewed or selected increases. In contrast, as hard disk drives and other storage devices become smaller the size of the display becomes limiting for overall device size. Because of the physical size of these devices, their displays are necessarily limited in both size (they must fit on the device) and resolution (the human eye can resolve only a finite number of pixels at a given distance). Selecting, browsing, and otherwise accessing images on such small displays is not well supported by existing user interfaces. Current approaches to browsing and managing large image collections almost universally use the ‘light table’ metaphor, where images are represented as reduced-resolution ‘thumbnail’ images, often presented on a large, scrollable 2-D region. Images can be marked by scrolling until a desired thumbnail is visible, then selecting the desired thumbnail using a pointing device such as a mouse.

The current approaches are not suitable for small displays for a number of reasons. A primary drawback is that the reduced size and resolution of a small display does not permit further reduction in the thumbnail images. Consider that sizes small enough to permit many thumbnails to be visible will be too small to see the individual pictures. Larger size images will allow only a very few thumbnails to be shown at once. Additionally, the scrolling and selecting operations typically require a mouse or pointer not usually found on small devices.

A hyperbolic non-linear function has been used successfully in the Hyperbolic Browser developed at PARC for browsing trees and hierarchies (Lamping, J., R. Rao, and P. Pirolli, ‘A Focus+Context Technique Based on Hyperbolic Geometry for Visualizing Large Hierarchies’ in Proc. CHI 95, ACM Conference on Human Factors in Computing Systems 1995, ACM: New York). Browsing images using thumbnails is extremely well known in the art. Variants on this include warping the images and/or thumbnails using perspective (Juha Lehikoinen and Antti Aaltonen Saving Space by Perspective Distortion When Browsing Images on a Small Screen, OZCHI 2003, 26-28 Nov. 2003, Brisbane, Australia) or other distortions (Y. K. LY. K. Leung and M. D. Apperley A Review and Taxonomy of Distortion-Oriented Presentation Techniques. In ACM Transactions on Computer-Human Interaction (TOCHI), vol. 1 issue 2 (June 1994), pp 126-140), or using variable thumbnail sizes (Johnson, B., Shneiderman, B. Treemaps: a space-filling approach to the visualization of hierarchical information structures. In Proc. of the 2nd International IEEE Visualization Conference pp. 284-291 San Diego, October 1991 and Shingo Uchihashi, Jonathan Foote, Andreas Girgensohn, and John Boreczky. Video Manga: Generating Semantically Meaningful Video Summaries. In Proceedings ACM Multimedia (Orlando, Fla.) ACM Press, pp. 383-392, 1999).

### SUMMARY OF THE INVENTION

This invention is a novel user interface for accessing multiple digital images. One embodiment of the invention, is applicable to small-format displays incorporated in handheld imaging devices such as digital cameras, camera-equipped cell phones, PDAs, and video cameras.

In this invention, algorithms to show multiple images at the maximum possible resolution are defined. Instead of reducing the resolution of each image, the portion that is actually shown is reduced. Selecting which part of each image to be shown is the subject of the invention.

### BRIEF DESCRIPTION OF THE DRAWINGS

Preferred embodiments of the present invention will be described in detail based on the following figures, wherein:

FIG. 1 illustrates a block diagram of an event flowchart for browsing multiple images in accordance with the present invention;

FIG. 2 shows (a) a conceptual ‘stack’ of images and (b) images cut away to reveal those below;

FIG. 3 shows a ‘composite’ image formed from the images of FIG. 2;

FIG. 4 shows the effect of the ‘scrub’ parameter, where ‘scrub’ is increased in (a)-(d) to include either different central images (large adjustment) and different adjacent images or different regions of an image (small adjustment) and different regions of the adjacent images in the ‘composite’ image;

FIG. 5 shows the effect of the ‘zoom’ parameter, where ‘zoom’ is increased in (a)-(d) to include progressively more of the central image and less and fewer of the neighboring images in the ‘composite’ image;

FIG. 6 illustrates an analogy where images are considered as a ‘stack’, and as shown in (a) a ‘slice’ through the ‘stack’ reveals in (b) overlapping regions in the ‘composite’ image;

FIG. 7 illustrates that varying the ‘zoom’ parameter can be equated with (a) changing the angle of the ‘slice’ intercept line in a stack of images, where as shown in (b) as the angle becomes more horizontal, fewer images are present in the ‘composite’ image;

FIG. 8 illustrates that varying the ‘scrub’ parameter can be equated with (a) changing the height of the intercept line in a stack of images, where as shown in (b) as the intercept line is lowered, images further down the stack are included in the ‘composite’ image;

FIG. 9 shows nonlinear image stack selections using an inverse tangent function, where ‘scrub’ and ‘zoom’ increase in (a)-(c), where the quantized function is shown as a solid line, and the unquantized function is shown as a dotted line;

FIG. 10 shows the effect of increasing ‘zoom’ in (a)-(c) for asteroidal image boundaries;

### DETAILED DESCRIPTION

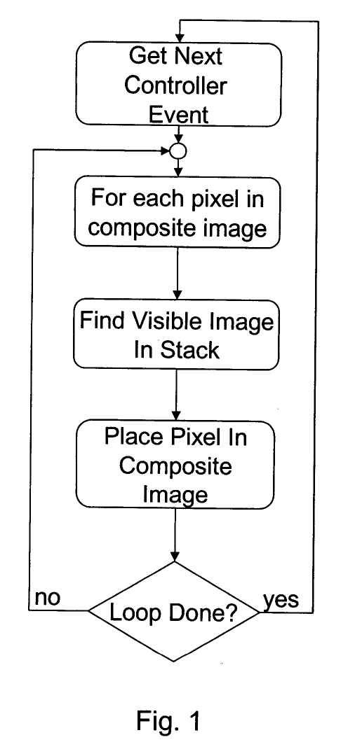

FIG. 1 shows a block diagram of an event flowchart for a PDA of other image browsing device in which the logic routine calculates a ‘composite’ image after every controller event, which returns visible images in accordance with the present invention. The composite image is made up of selected pixels from the images.

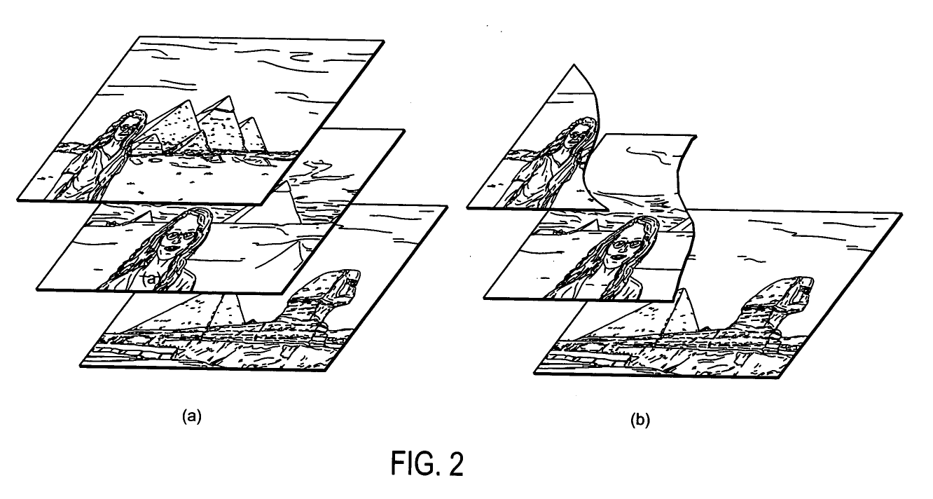

FIG. 2(a) shows images stacked on top of each other like a pile of photographic prints, which will be referred to as the ‘stack analogy’. Removing a region of the top image will reveal a portion of the image below. Cutting away a region of the image so exposed will then reveal the image beneath, and so forth as in FIG. 2(b). In this manner, portions of multiple images can be displayed at full resolution on a single small display. Images of different size or aspect ratio are resized, padded, and/or cropped for best display at the available resolution and aspect ratio. Although FIG. 2 shows only three images, it should be noted that these methods can be generalized to an arbitrary number of images. It is assumed that images are stacked in some natural order, such as by timestamp, file name, or similarity to a search query. The images may also be selected from a digital video stream. Thus, the method for browsing may be used as a means of rapidly browsing a video when searching for a particular relevant scene.

It may be that a static image produced in this way will be unsatisfactory, as the majority of the images can be obscured by the images at higher positions in the stacking order. In one embodiment of this invention, methods to dynamically change the revealed regions of each image in a fluid and rapid manner are proposed. Thus over a small amount of time many images can be fully viewed, even if only part of an image is exposed at a time.

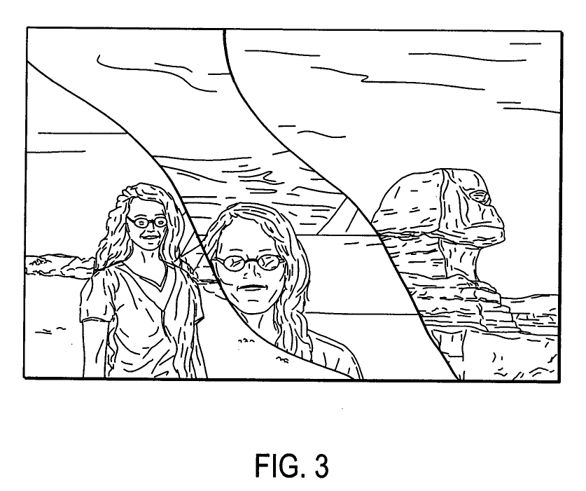

In one embodiment of the invention, a ‘composite’ image is formed by one or more overlapping images with regions partially removed. FIG. 3 shows an example of a ‘composite’ image formed, according to one embodiment of the invention, from the three images of FIG. 2(b). In one embodiment of the invention, in a ‘composite’ image, one of the visible images is considered the ‘central’ image. In an embodiment of the invention, the ‘central’ image will typically, but not always, be the middle image seen in the ‘composite’. For example, the middle image of FIG. 2 is the ‘central’ image in the composite of FIG. 3. In an embodiment of the invention, the other visible images are nearby in the stack order, while images further away are obscured.

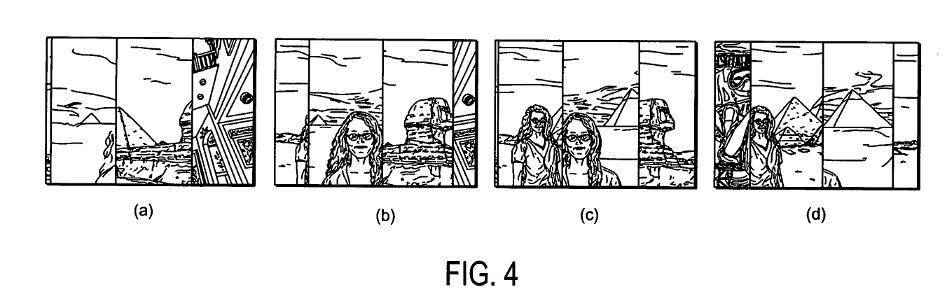

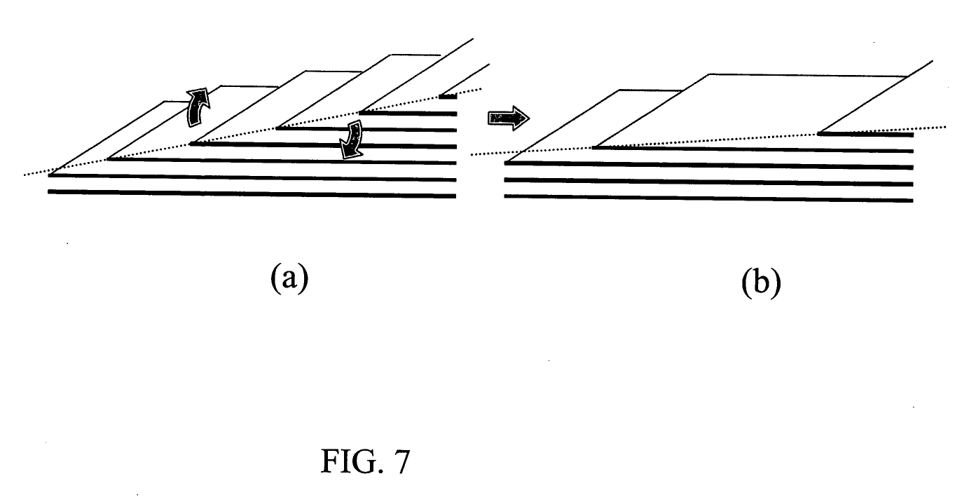

In an embodiment of the invention, parameters can be changed over time to reveal the different images and to change the region of each included in the ‘composite’ image. In an embodiment of the invention, ‘scrub’ is such a parameter (in analogy with the video editing technique to move precisely forward and backward in time). In an embodiment of the invention, ‘scrubbing’ selects the central image and thereby the neighboring images, i.e., the ‘set of display images’. Changing the ‘scrub’ parameter successively includes new images from the stack while hiding previously visible ones in the ‘composite’ image. Scrubbing moves the visible images up and down the stack (see FIG. 4). The effect of scrubbing is shown in the ‘stack analogy’ (see FIG. 7). FIG. 4 shows the effect of large adjustments in ‘scrub’. In FIG. 4 large adjustments in ‘scrub’ result in the inclusion of different central images in the ‘composite’ image (e.g., FIG. 4(a) compared with FIG. 4(b) or FIG. 4(c) compared with FIG. 4(d)). In contrast, the effect of small adjustments in ‘scrub’ includes different regions of the same image (e.g., FIG. 4(b) compared with FIG. 4(c)) and different regions of the adjacent images in the ‘composite’ image. In an embodiment of the invention, rapidly scrubbing through the images can show all parts of every image, over time, at the highest possible resolution.

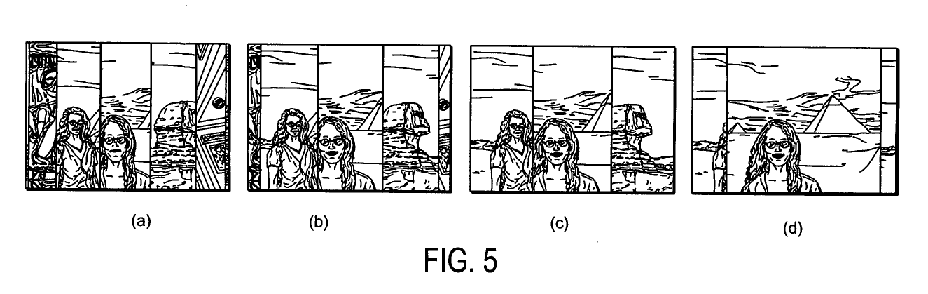

‘Zoom’ is another parameter, which can be used to control the displayed ‘set of display images’. FIG. 5 illustrates changing the exposure of the central image. In an embodiment of the invention, ‘zoom’ does not change the image scale (as the term is conventionally used). Rather, ‘zoom’ changes the extent to which the central image is exposed (and the neighboring images are hidden). In an embodiment of the invention, when ‘zoom’ is maximized, only the central image is displayed in the ‘composite’ image. Decreasing the ‘zoom’ includes progressively more of the neighboring images, see FIG. 5(a) compared with FIG. 5(d) in the ‘composite’ image. At the limit of minimum ‘zoom’, a maximum number of images are included in the ‘composite’ image. In an embodiment of the invention, the minimum ‘zoom’ is limited to a predetermined number of images. This number depends on how many images can be simultaneously imaged on the available display, as well as what is practical to view by a typical user. In practice, this may be far fewer than the total number of available images.

User Interaction

In an embodiment of the invention, the user is able to smoothly and quickly adjust the ‘zoom’ and ‘scrub’ parameters over a natural range. In an embodiment of the invention, the range allows that all images can be included in the ‘composite’ image over time and thereby viewed. Control over each parameter is ideally provided by a smoothly variable input device, such as a slider, dial, thumbwheel, or one axis of a joystick, mouse, stylus, or similar pointing device. In an embodiment of the invention, an interface that may be particularly suitable for small form-factor devices are tilt sensors; tilting left or right can ‘scrub’ deeper or shallower into the image collection, while tilting forwards or backwards can increase or decrease the ‘zoom’. In an embodiment of the invention, fully ‘zooming’ into a particular image is used to ‘select’ that image for further operations, such as marking, printing, copying, or deletion.

Image View Regions

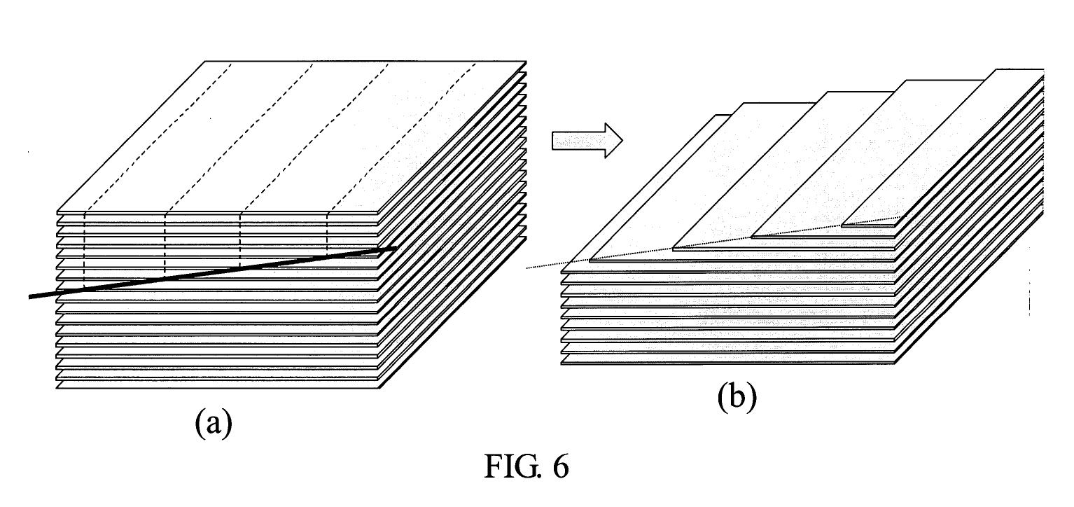

The extent of the visible region is determined for the ‘composite image’, given values for the ‘scrub’ and ‘zoom’ parameters. In different embodiments of the invention, there are a large number of possible mappings. Consider one in detail so that it can be understood and extended. This mapping is explained using the ‘stack analogy’. For simplicity, visible regions are considered as rectangles that are the same height as the display (however, as discussed above in an embodiment of the invention, all images can be resized by padding or cropping to the best aspect ratio). Seen from the side, the images look like an array of parallel lines, as shown in FIG. 6. In an embodiment of the invention, a diagonal line (see FIG. 6(a)) across the stack will intersect the images at regular intervals (we assume the images are evenly spaced in the stack). These locations can be used as the boundaries of the visible regions, as shown in FIG. 6(b). In this embodiment, the composite image is constructed from rectangular portions of images in the stack. Each vertical column in the composite image comes from a single image in the stack. Thus, the function that determines which image is visible at each point is one dimensional. This construction lets us control the ‘zoom’ and ‘scrub’ effects by changing the angle and height of the intercept line. For example, rotating the line to become more horizontal is equivalent to increasing the ‘zoom’, as it will intercept fewer images and thus reveals more of each as shown in FIG. 7. In FIG. 7(a), the intersecting line reveals six layers, thus six images are shown. As the intercept line is tilted away from the vertical, the intersecting line reveals only three layers, thus three images are shown (see FIG. 7(b)). As mentioned before, it is generally desirable to limit the maximum ‘zoom’; this is easily done by limiting how close to vertical the intercept line may be angled.

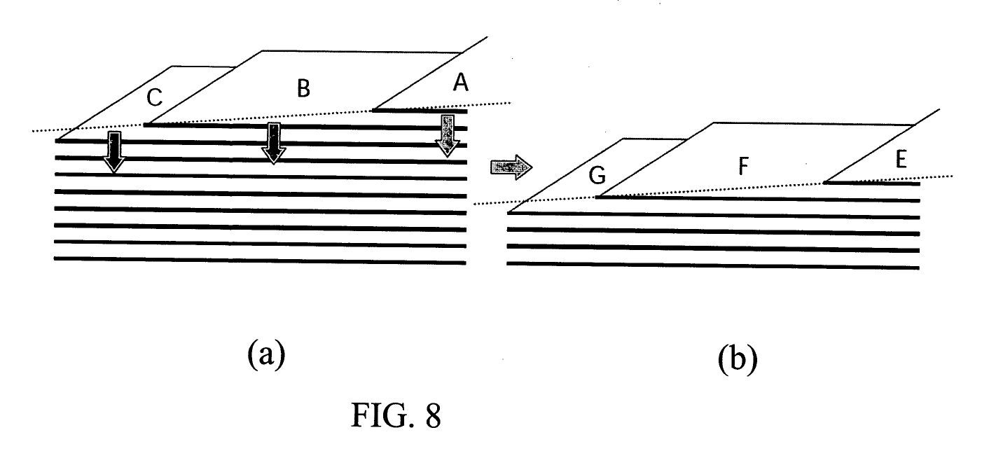

Moving the intercept line up and down changes the ‘scrub’, as successive images are revealed or concealed as shown in FIG. 8. In FIG. 8(a), the topmost images A, B, and C are revealed. As the intercept line is moved downwards, progressively deeper images are revealed until images E, F, and G are visible (see FIG. 8(b)).

In an embodiment of the invention, ‘zoom’ and ‘scrub’ are orthogonal or independent; that is, the ‘zoom’ (angle) can be changed without affecting the ‘scrub’ (height), and vice-versa. In practice, this is a generally desirable property.

Nonlinear Boundaries

In an embodiment of the invention, image boundaries are more interesting than the equal-sized rectangles displayed in FIGS. 7 and 8. The image boundaries produce the ‘composite boundary’ i.e., a plurality of image boundaries each applicable to one of the ‘set of display images’ produces a ‘composite boundary’ for the ‘composite image’. Ideally, the image boundaries are ‘organic’ and the resulting composite image is smooth and pleasing to the eyes. Similarly, as the composite image is varied with time, the change in the composite boundary results in a composite image, which is smooth and pleasing to the eyes and the tactile senses of the user controlling them. In an embodiment of the invention, this is effected using non-linear boundaries, which control the widths and shapes in a non-linear manner. The non-linear boundaries are used to convey a sense of natural fluid motion.

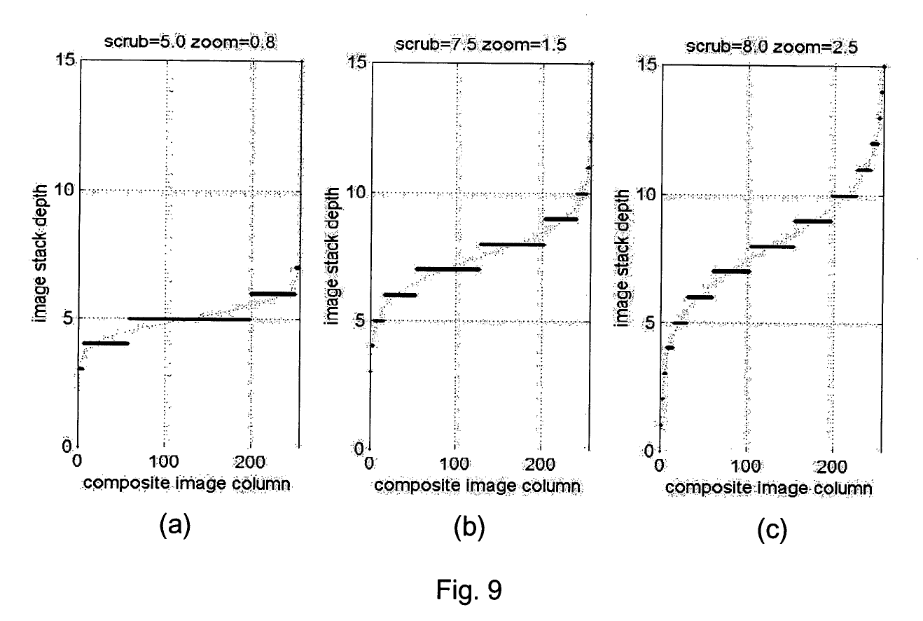

In an embodiment of the invention, a non-linear function can work better than the equal-sized rectangles of FIGS. 7 and 8, even given straight boundaries. In an embodiment of the invention, an inverse hyperbolic tangent function can be used instead of the straight line to determine horizontal (or vertical) boundaries of different width. In an embodiment of the invention, adding an offset to the function controls the ‘scrub’ parameter, just as shifting the intercept line does. ‘Zoom’ can be controlled by scaling the input argument to the function, so that the central region becomes flatter, and thus the central boundaries are farther apart. A specific embodiment uses the function, given in equation 1, to determine for each column, x, (0≦x<width), in the composite image the depth, depth, in the image stack to use in the composite image, given current values of zoom and scrub. FIG. 9 shows the effect of changing ‘scrub’ (offset) and ‘zoom’ (scaling) on this function over a hypothetical stack of 15 images. FIG. 9(a) shows the function for scrub value of 5 and zoom value of 0.8. FIG. 9(b) shows the function for scrub value of 7.5 and zoom value of 1.5, and FIG. 9(c) for scrub value of 8 and zoom value of 2.5. The image selection function plotted with solid lines has been quantized to integer values as described in the preceding equation to show the visible image boundaries. The non-quantized inverse hyperbolic tangent function is shown as a dotted line. This hyperbolic function has the primary advantage that the central image will always have the largest visible region (unlike linear boundaries which have equal areas). Thus, the central image is emphasized, and ‘scrubbing’ to a desired image becomes easier. It also has the aesthetic advantage in that boundaries become compressed towards each edge, and ‘peel off’ during ‘scrubbing’ in a visually pleasing manner.
depth=round(zoom*atanh((2x−width)/width+scrub) equation 1

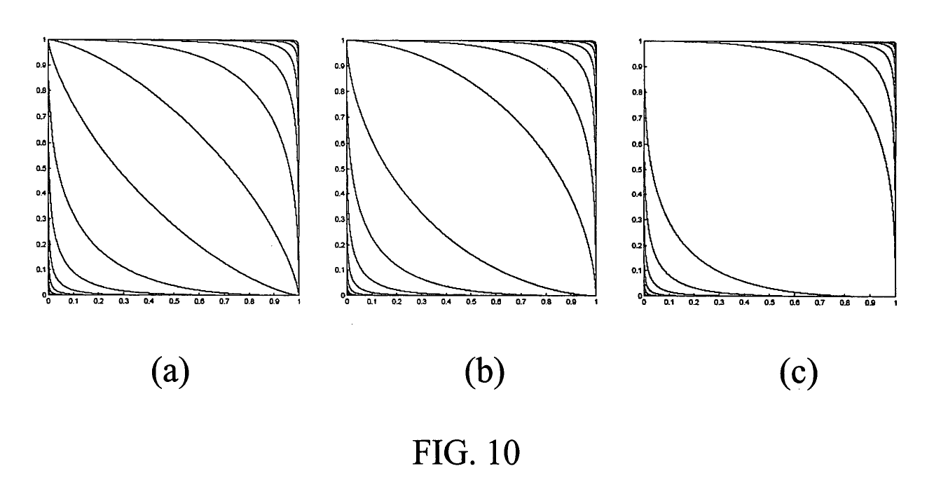

In an embodiment of the invention, image boundaries can change non-linearly in time and space. A full exploration of possible mappings can be appreciated by one of skill in the art. Additional embodiments of the invention that have functional and/or aesthetic value are presented. In an embodiment of the invention, a non-linear image boundary function is used as shown in FIG. 10. These are computed from the parametric asteroidal function x=cos^{γ}(t) and y=sin^{γ}(t), where the parameter t varies over the first quadrant (0<t<π/2) and the exponent γ controls the curve of the boundary (2<γ<∞). In an embodiment of the invention, γ=2 results in a diagonal straight line; as γ increases the curvature increases asymptotically to the axis boundaries. In FIG. 10, the value of the parameter γ is increasing from FIG. 10(a) to 10(c). That is, the value is larger in 10(b) than in 10(a), and larger in 10(c) than in 10(b).

This representation has the advantage that all pictures become ‘clumped up’ in the corners and it is possible to estimate how many pictures are in the collection by the density of boundaries, even if the individual images are not visible. In addition, the image can easily be rotated 90 degrees. This can assist searching for image features in a particular region (for example if a user searches for a face in the top left corner, the boundary representation can be rotated so the top left is always in the central image and thus visible).

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

Various embodiments of the invention may be implemented using a processor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits and/or by interconnecting an appropriate network of component circuits, as will be readily apparent to those skilled in the art.

Various embodiments include a computer program product which can be a storage medium (media) having instructions and/or information stored thereon/in which can be used to program a general purpose or specialized computing processor(s)/device(s) to perform any of the features presented herein. The storage medium can include, but is not limited to, one or more of the following: any type of physical media including floppy disks, optical discs, DVDs, CD-ROMs, micro drives, magneto-optical disks, holographic storage devices, ROMs, RAMs, EPROMs, EEPROMs, DRAMs, PRAMS, VRAMs, flash memory devices, magnetic or optical cards, nano-systems (including molecular memory ICs); paper or paper-based media; and any type of media or device suitable for storing instructions and/or information. Various embodiments include a computer program product that can be transmitted in whole or in parts and over one or more public and/or private networks wherein the transmission includes instructions and/or information, which can be used by one or more processors to perform any of the features, presented herein. In various embodiments, the transmission may include a plurality of separate transmissions.

Stored on one or more computer readable media, the present disclosure includes software for controlling the hardware of the processor(s), and for enabling the computer(s) and/or processor(s) to interact with a human user or other device utilizing the results of the present invention. Such software may include, but is not limited to, device drivers, interface drivers, operating systems, execution environments/containers, user interfaces and applications.

The execution of code can be direct or indirect. The code can include compiled, interpreted and other types of languages. Unless otherwise limited by claim language, the execution and/or transmission of code and/or code segments for a function can include invocations or calls to other software or devices, local or remote, to do the function. The invocations or calls can include invocations or calls to library modules, device drivers, interface drivers and remote software to do the finction. The invocations or calls can include invocations or calls in distributed and client/server systems.

What is claimed is:

1. A method of generating a composite image from a plurality of images comprising the steps of:
(a) selecting a ‘zoom’ and a ‘scrub’ parameter;
(b) generating a set of display images from the plurality of images based on the parameters; and
(c) generating the composite image based on the set of display images.

2. The method of claim 1, further comprising the steps of:
(d) selecting one or more image boundaries for the composite image; and
(e) generating the composite image based on the plurality of boundaries.

3. The method of claim 2, wherein one or more image boundaries are non-linear image boundaries.

4. The method of claim 3, wherein one or more image boundaries are defined by inverse hyperbolic tangent functions.

5. The method of claim 3, wherein one or more image boundaries are defined by parametric asteroidal functions.

6. The method of claim 3, wherein a function defined by x=cos^{γ}(t) and y=sin^{γ}(t) is used to select the image boundaries, where 0<t<π/2 and 2<γ<∞.

7. The method of claim 1, wherein one or both of the ‘zoom’ and the ‘scrub’ parameter is changed in a fluid manner over time.

8. The method of claim 1, wherein one or both of the ‘zoom’ and the ‘scrub’ parameter is changed in a rapid manner over time.

9. The method of claim 1, which further comprises the step of ordering the set of display images and generating the composite image of the set of ordered display images.

10. The method of claim 9, wherein the set of ordered display images are ordered based on a parameter selected from the group consisting of the image file timestamp, file name, or similarity to a search query.

11. The method of claim 9, wherein other visible images in the composite image are nearby in order to the central image, while images further away in order from the central image are obscured or not present in the composite image.

12. The method of claim 1, which further comprises the step of displaying the composite image.

13. The method of claim 12, further comprising the step of dynamically changing one or both of the ‘zoom’ and the ‘scrub’; thereby changing the composite image displayed over time.

14. The method of claim 13, wherein one or both of the ‘zoom’ and the ‘scrub’ is used to select one or more images for one or more further operations; where the operations are selected from the group consisting of marking, printing, copying and deleting.

15. The method of claim 1, wherein the images are selected from a video stream.

16. A method for generating a composite image, made up of a region of interest of a central image and one or more neighboring images, from a plurality of ordered images comprising the steps of:
(a) selecting one or both of a ‘zoom’ and a ‘scrub’ parameter;
(b) selecting a set of display images from the plurality of images based on the parameter;
(c) selecting a composite boundary based on one or more image boundaries; and
(d) generating the composite image based on the set of display images and the composite boundary.

17. The method of claim 16, further comprising the step of displaying the composite image.

18. A device for displaying a composite image from a plurality of images comprising:
(a) means for generating a ‘zoom’ and a ‘scrub’ parameter;
(b) means for selecting a set of display images from the plurality of images based on the parameters;
(c) means for selecting one or more image boundaries;
(d) means for generating a composite boundary based on the plurality of image boundaries;
(e) means for generating the composite image based on the set of display images and the composite boundary; and
(f) means for displaying the composite image.

19. A system or apparatus for displaying a composite image of a plurality of images wherein displaying the composite image comprises:
a) one or more processors capable of specifying one or more sets of parameters; capable of transferring the one or more sets of parameters to a source code; capable of compiling the source code into a series of tasks for displaying the composite image of the plurality of images; and
b) a machine readable medium including operations stored thereon that when processed by one or more processors cause a system to perform the steps of specifying one or more sets of parameters; transferring one or more sets of parameters to a source code; compiling the source code into a series of tasks for displaying the composite image of the plurality of images.

20. A machine-readable medium to display a composite image representative of a plurality of images, wherein the medium has instructions stored thereon to cause a system to:
(a) select a ‘zoom’ and a ‘scrub’ parameter;
(b) generate a set of display images from the plurality of images based on the parameters;
(c) select one or more image boundaries;
(d) determining a composite boundary based on the plurality of image boundaries;
(e) generate a composite image based on the set of display images and the composite boundary; and
(f) display the composite image.
